(19) United States
(12) Patent Application Publication
(10) Pub. No.: US 2013/0179281 A1
(43) Pub. Date: Jul. 11, 2013

(54) SYSTEM AND METHOD FOR OFFLINE STAND-IN OF FINANCIAL PAYMENT TRANSACTIONS

(71) Applicant: Mocapay, Inc., Denver, CO (US)

(72) Inventors: William O. White, Boulder, CO (US); Douglas Dwyre, Castle Pines, CO (US); James Ray, Oakland, CA (US)

(73) Assignee: Mocapay, Inc., Denver, CO (US)

(21) Appl. No.: 13/736,738

(22) Filed: Jan. 8, 2013

Related U.S. Application Data
(60) Provisional application No. 61/584,884, filed on Jan. 10, 2012.

(51) Int. Cl. G06Q 20/38

(52) U.S. Cl. CPC G06Q 20/382
USPC 705/21

(57) ABSTRACT

Methods, systems, and devices are disclosed for conducting offline transactions using mobile devices at a point of sale device while the point of sale device is disconnected from a network. The point of sale device may receive a mobile transaction code from a mobile device, the mobile transaction code associated with an offline transaction between the mobile device and the point of sale device. The point of sale device may compare the received mobile transaction code at the point of sale device to at least one stored offline stand-in transaction code in response to a determination that the point of sale device is disconnected from the network, determine that the offline transaction is preauthorized based on the comparison, and complete the off-line transaction based on the determination that the offline transaction is preauthorized

### CROSS REFERENCES

The present application claims priority under 35 U.S.C. §119 to U.S. Provisional Patent Application No. 61/584,884, entitled “System and Method for Offline Stand-In of Financial Payment Transactions,” filed on Jan. 10, 2012, the entire disclosure of which is incorporated herein by reference for all purposes.

### BACKGROUND

The present specification relates generally to electronic commerce. More specifically, but not by way of limitation, the present specification relates to systems and methods for conducting wireless payment transactions when a wireless network is unavailable.

Internet and/or network connections are not ubiquitous and cannot be guaranteed to be available in all locations at all times. However, certain payment systems rely upon the availability of wireless and/or wired networks in order to complete financial transactions. When payment systems require the use of a wireless and/or wired network, the unavailability of a network may result in a failure to complete a financial transaction. Parties to a transaction cannot always accurately predict whether a network will be available when a user is choosing to patronize the merchant. If a user relies upon a mobile device as his or her payment method and the merchant does not have access to a network (either a wired or wireless network), the merchant may be left with no other means of receiving payment for the service or goods to be purchased by the user.

Certain point of sale terminals support store and forward functionality, in which payment details for transactions are collected from a customer without the point of sale terminal being connected to a phone line or network. The transactions are later processed when a connection is available. However, none of the store and forward solutions currently available to a merchant allows the merchant to have confidence that each and every payment transaction accepted while offline will actually be approved once the merchant connects to a network. With the current solutions, merchants take the risk that the users who patronize the merchant while the merchant is offline are able to fund the transaction.

Accordingly, there may be a need to provide an out-of-network option to allow the use of mobile devices to conduct payment transactions even when a wireless network is unavailable.

### SUMMARY

Systems, methods, and devices are disclosed which allow a point of sale device to authorize and complete transactions even when the point of sale device is not connected to a network.

In a first set of embodiments, a method of conducting transactions may include receiving, at a point of sale device, a mobile transaction code from a mobile device associated with a user. The mobile transaction code may be associated with an offline transaction between the mobile device and the point of sale device during which the point of sale device is disconnected from a network. The method may further include comparing the received mobile transaction code at the point of sale device to at least one stored offline stand-in transaction code in response to a determination that the point of sale device is disconnected from the network, determining at the point of sale device that the offline transaction is preauthorized based on the comparison of the received mobile transaction code to the at least one offline stand-in transaction code; and completing the off-line transaction based on the determination that the offline transaction is preauthorized.

In a second set of embodiments, a method for conducting transactions at a payment authority server may include: transmitting a set of offline stand-in transaction codes generated at the payment authority server to a point of sale device; transmitting at least one of the offline stand-in transaction codes to a mobile device; receiving, from the point of sale device, an indication that one of the stand-in transaction codes was received at the point of sale device from the mobile device in connection with an offline transaction during which the point of sale device and the payment authority server were disconnected; and settling the offline transaction based on the indication received from the point of sale device.

In a third set of embodiments, a point of sale device may include a processor and a memory communicatively coupled with the processor. The memory may store instructions executable by the processor to: receive a mobile transaction code from a mobile device associated with a user, the mobile transaction code associated with an offline transaction between the mobile device and the point of sale device during which the point of sale device is disconnected from a network; compare the received mobile transaction code at the point of sale device to at least one stored offline stand-in transaction code in response to a determination that the point of sale device is disconnected from the network; determine at the point of sale device that the offline transaction is preauthorized based on the comparison of the received mobile transaction code to the at least one offline stand-in transaction code; and complete the off-line transaction based on the determination that the offline transaction is preauthorized.

In a fourth set of embodiments, a point of sale device may include a processor and a memory communicatively coupled with the processor. The memory may store instructions executable by the processor to: transmit a set of offline stand-in transaction codes generated at the payment authority server to a point of sale device; transmit at least one of the offline stand-in transaction codes to a mobile device; receive, from the point of sale device, an indication that one of the stand-in transaction codes was received at the point of sale device from the mobile device in connection with an offline transaction during which the point of sale device and the payment authority server were disconnected; and settle the offline transaction based on the indication received from the point of sale device.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention;

FIG. 2 is a diagram showing example interactions among various entities during transactions, according to various embodiments of the invention;

FIG. 3 is a schematic diagram that illustrates an example point of sale device that may be used in various embodiments of the present invention;

FIG. 4 is a diagram of an example system for conducting transactions configured according to various embodiments of the invention;

FIG. 5 is a schematic diagram that illustrates an example payment authority server that may be used in various embodiments of the present invention;

FIG. 6 is a diagram of an example system for conducting transactions configured according to various embodiments of the invention;

FIG. 7 is a flow chart of a portion of an example method for conducting an offline transaction from the perspective of a point of sale device, according to various embodiments of the invention;

FIG. 8 is a flow chart of a portion of another example method for conducting an offline transaction from the perspective of a point of sale device, according to various embodiments of the invention;

FIG. 9 is a flow chart of a portion of an example method for conducting an offline transaction from the perspective of a payment authority server, according to various embodiments of the invention; and

FIG. 10 is a flow chart of a portion of an example method for conducting an offline transaction from the perspective of a payment authority server, according to various embodiments of the invention.

### DETAILED DESCRIPTION OF THE INVENTION

In the systems, methods, and devices of the present application, a set of offline stand-in transaction codes for a merchant may be stored both at a payment authority server and a point of sale device associated with the merchant. When a user of a mobile device chooses to conduct a transaction at the point of sale device while the point of sale device is disconnected from a real-time authorization service from a payment authority, the point of sale device may receive a mobile transaction code from the mobile device. The point of sale device may compare the mobile transaction code to the set of offline stand-in transaction codes, and if the mobile transaction code received from the mobile device matches one of the set of offline stand-in transaction codes, the point of sale device may authorize the transaction. When connectivity to the payment authority server returns, the point of sale device may communicate the transaction to the payment authority server to settle the authorized transaction.

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

As used in the present disclosure and appended claims, the term “merchant” is to be broadly construed as a provider of goods and services.

As used in the present disclosure and the appended claims, the term “transaction code” refers broadly to an alphanumeric, binary, or other type of code provided by a mobile device to obtain authorization of a pending transaction without disclosing an account number.

As used in the present disclosure and the appended claims, the term “offline transaction” refers to a transaction between a mobile device and a point of sale system during which either the mobile device or the point of sale system is disconnected from a payment authority system.

A mobile payment card, for the purposes of discussion in this application, refers to any of the items in the mobile device-side wallet that can include gift card numbers, credit or debit card numbers, and the like as such numbers are stored in the server-side digital wallet. A “mobile payment card” is, thus, a digital construct (stored digital data) that replaces a physical (e.g., plastic, magnetically encoded) payment card.

A mobile-payment-card platform in accordance with these illustrative embodiments may provide, among other things, a server-side digital wallet and a mobile device-side wallet for mobile payment cards that overcomes the shortcomings (e.g., risk of loss or theft) associated with other payment methods that reside within the mobile device itself The server-side digital wallet, the mobile device-side wallet and the relationship between the two are described more fully in U.S. Pat. No. 7,657,489, the specification of which is incorporated in its entirety herein.

In these illustrative embodiments, credentials (account numbers, balances, or other sensitive information) associated with a user's payment methods may reside somewhere other than the mobile device itself A secure network infrastructure may distribute and manage the payment methods and their associated credentials, the mobile device acting merely as one means for the user to communicate with the server-side digital wallet and the merchant system to access a variety of flexible services surrounding use of the mobile payment methods. The merchant system may include, but is not limited to, the point of sale devices, computers, networks and back end systems for managing the merchant's business.

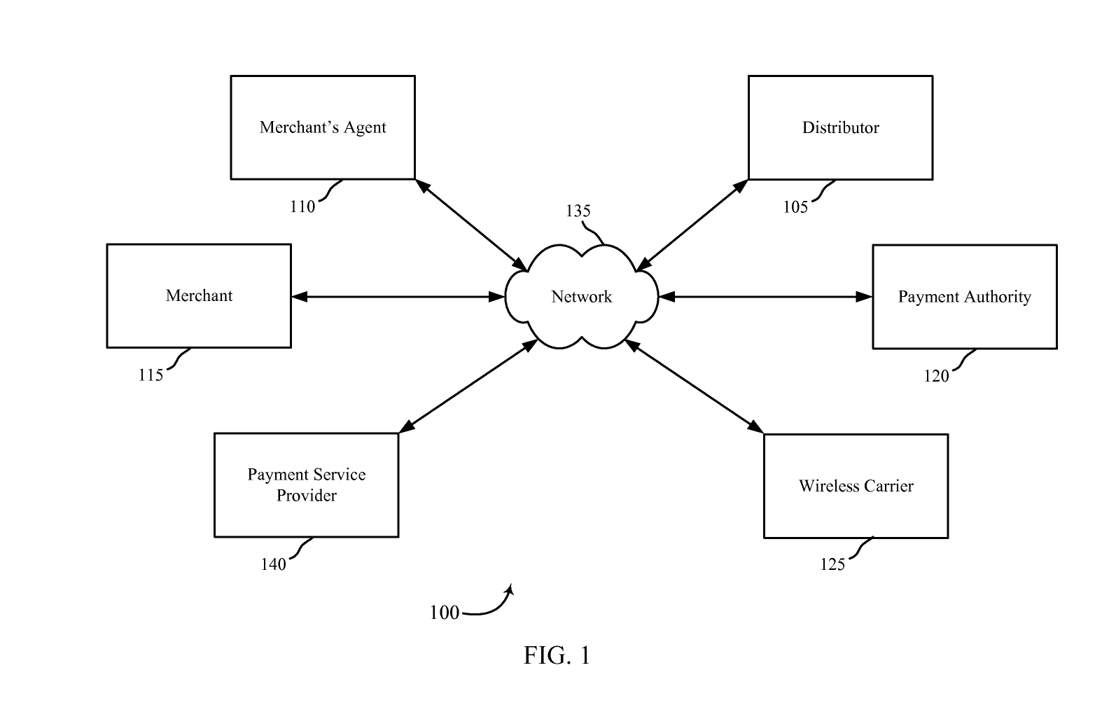

FIG. 1 illustrates a functional block diagram of a system 100 in which various illustrative embodiments of the invention can be implemented. In system 100, distributor 105, merchant's agent 110, merchant 115, payment authority 120, wireless carrier 125, and payment service provider 140 may be able to communicate with one another via network 135. A user's mobile device—e.g., a cellular or Personal Communication Service (PCS) phone—may also be able to communicate with nodes connected with network 135 via wireless carrier 125. In some embodiments, network 135 includes, but is not necessarily limited to, the Internet.

It will be understood that the wireless network utilized by the mobile device referred to herein may be a cellular communication network such as a GSM network, a COMA network, a 3G network, a 4G network, WiFi, WiMAX, etc. Further, it will be understood that the mobile device can communicate with the payment card management platform via the Internet or the World Wide Web. Also, the mobile device may connect to the payment card management platform via one or more wired or wireless Metropolitan Area networks (MANs); one or more wired or wireless local area networks (LANs); one or more wired or wireless Wide Area networks (WANs); one or more wired or wireless Personal Area networks (PANs); etc. Further, it will be understood that the various components are configured to communicate using the requisite communication protocols and signal schemes.

The system 100 in FIG. 1 may build on existing payment systems operated by payment service providers 140 such as, without limitation, MOCAPAY, FIRST DATA and COMDATA. Payment service provider 140, among other things, may administer the financial aspects of payment cards or other accounts, including keeping track of the balance associated with a particular payment method, settlement, reporting to merchants, and other functions.

Merchant 115 may sell goods, services, or both to consumers either directly or with the assistance of merchant's agent 110. For example, merchant's agent 110 may facilitate the distribution and sale of payment cards issued by merchant 115 by acting as an intermediary between merchant 115 and any of the following: (1) a payment-card service provider 140, (2) mobile-payment-card distributors 105, (3) mobile-payment-card purchasers (those giving the mobile payment cards to others), and (4) mobile-payment-card recipients (consumers who use the mobile payment cards in commerce). A consumer holding such a mobile payment card can use the mobile device to purchase goods or services from the particular merchant that issued the mobile payment card, as explained above. How the holder of a mobile payment card uses the mobile device to make purchases from the issuing merchant is discussed further below. As should be understood from one skilled in the art, the use of the mobile device described herein is not limited to the strict use of a physical card or an account with a cash balance, but may also include the use of loyalty accounts, coupons, gift cards, or other incentives.

Payment authority 120 may be the source of funds for transactions carried out from a user's mobile device such as the user's reloading of a mobile payment card or purchase of a mobile payment card on behalf of someone else. In such transactions, payment authority 120 may act as an agent of the merchant to collect funds from the user's credit card or other payment source. In some examples, an entity acting as a payment authority 120 in certain contexts may also be a distributor 105 in other contexts.

Distributor 105 may market mobile payment cards and, in some embodiments, may be somewhat analogous to an entity such as a grocery store chain which markets conventional plastic, magnetically encoded payment cards for a variety of other merchants on racks in its grocery stores with the assistance of a conventional-payment-card merchant's agent. Distributor 105 can take on a variety of different forms, depending on the particular embodiment.

In one example, distributor 105 may be an entity (not necessarily a merchant) that operates a Web site or other electronic communication channel where payment cards for a number of different merchants are offered in an aggregated fashion. In another embodiment, a single merchant markets its payment cards via remote distribution channels, local distribution channels, or both. For example, a merchant may market its payment cards via a remote distribution channel such as a Web site or other networked electronic communication channel using Application Programming Interfaces (APIs) supplied by merchant's agent 110 or another entity. That is, a merchant may use flexible APIs provided by merchant's agent 110 to customize a Web site or other networked electronic communication channel to offer its payment cards in a manner consistent with the merchant's particular brand identify, logos, etc. A merchant may also employ local distribution methods in a store (at the point of sale). In such examples, the payment card can be “mobilized” (made accessible to the recipient via the recipient's mobile device) at the point of sale.

In yet another embodiment, distributor 105 may be a social networking Web site where the interests and preferences of a potential mobile-payment-card recipient are revealed to that person's friends and family. For example, John may discover on a social networking web site that his friend Alan likes to shop at a particular merchant, and John can purchase a mobile payment card for that merchant at the social networking site for Alan. The above are merely a few examples of distributors 105. Mobile payment cards can be marketed in a wide variety of ways and settings.

In an illustrative embodiment, merchant 115 receives the funds from a user's purchase of a mobile payment card minus a predetermined fee that is paid to the merchant's agent 110.

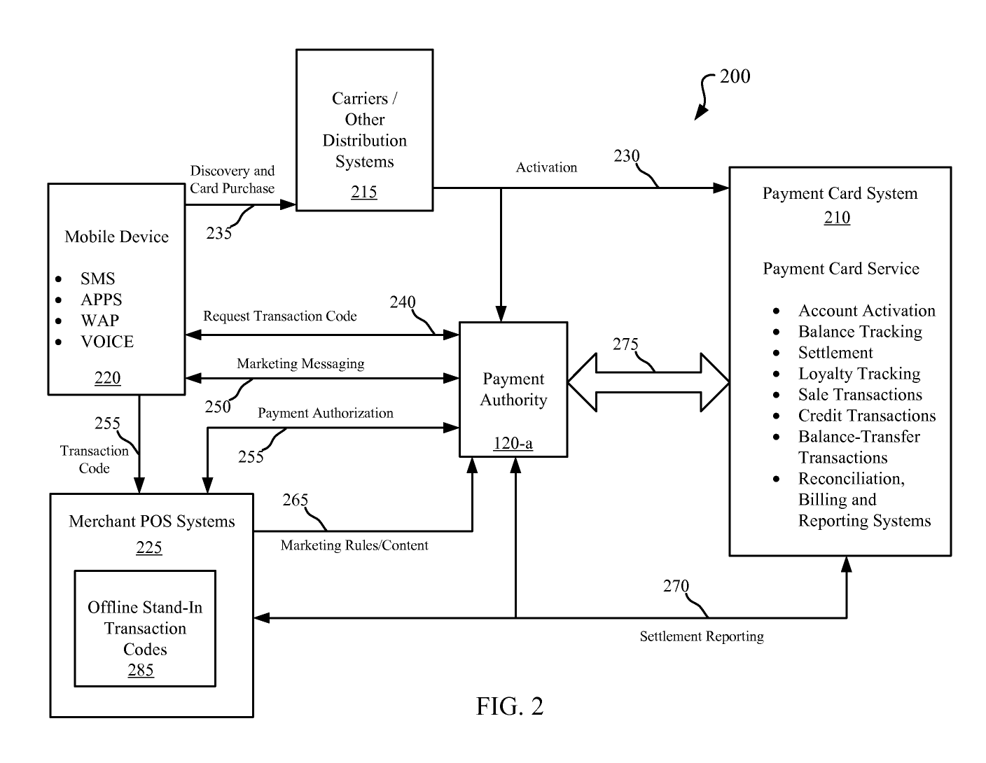

FIG. 2 shows example interactions among various entities involved in the distribution and use of mobile payment accounts in a system 200, in accordance with an illustrative embodiment of the invention. In FIG. 2, payment card system 210 may include a system operated by a conventional payment-card service provider 140 such as, without limitation, FIRST DATA or COMDATA. Various embodiments of the invention preserve the existing payments infrastructure supporting the use of payment cards or other types of payment accounts and overlay them with a payment authority 120-a, which is explained below. Other entities involved are a merchant point of sale system 225, a mobile device 220, and carriers or other entities (“CARRIERS/OTHERS” in FIG. 2) 215 and their associated distribution systems (see distributor 105 in FIG. 1). In the discussion of FIG. 2 below, interactions among these entities are identified by their corresponding reference numerals in parentheses.

In some embodiments, mobile device 220 can use a variety of different access methods such as, without limitation, Short Message Service (SMS) messages, Multimedia Message Service (MMS) messages, Wireless Access Protocol (WAP), an application, or voice to obtain perishable transaction codes 240 from payment authority 120-a in making payments from a variety of different tenders (forms of payment), including mobile payment cards. Mobile device 220 can also use a variety of methods, including Near Field Communications (NFC) and any of the above examples, to provide one-use perishable transaction codes to merchant point of sale systems 225 in making electronic purchases 260.

For example, mobile device 220 may receive a perishable transaction code 240 as evidence of pre-authorization by payment authority 120-a for a specific transaction. Mobile device 220 may provide the perishable transaction code 240 to a merchant point-of-sale (POS) system 225 to pay for a transaction via NFC communications or another method, and the merchant POS system 225 may receive payment authorization from the payment authority based on the perishable transaction code. Additional details and examples regarding the use of perishable transaction codes 240 can be found, for example, in the aforementioned '489 patent.

A user of mobile device 220 may also receive targeted marketing messages 250 before, during, or after a mobile purchase via payment authority 120-a and may purchase 235 mobile payment cards from a carrier 215 or other distributor 105 such as a social networking Web site. The targeted marketing messages may be assisted by the ability of merchant point of sale system 225 to submit marketing rules, content, or both 265 to payment authority 120-a.

Payment authority 120-a may be an example of payment authority 120-a described above with reference to FIG. 1. Payment authority 120-a may facilitate the activation 230 of mobile payment cards sold by a carrier or other entity 215 (or other distributor 105) in cooperation with payment card system 210 via communication link 275. Payment card system 210 may also provide, among other things, settlement and reporting services 270 to the merchant.

When the user of mobile device 220 wishes to make a purchase transaction using a mobile payment account associated with payment authority 120-a, mobile device 220 may contact payment authority 120-a using any of a variety of access methods (e.g., SMS, MMS, WAP, HTTP, or other browser technology, application, voice) to provide an optional personal identification number (PIN) or other authentication credential by which payment authority 120-a may authenticate mobile device 220. Payment authority 120-a may provide mobile device 220 with one-time perishable (time-limited) transaction codes 240 and balances for various tenders available to that user, including mobile payment cards. In the present example, the user of mobile device 220 may select a specific mobile payment card to be used in making the purchase.

The user of the mobile device 220 may provide 260 the received transaction code associated with the selected tender to the merchant point of sale system 225. If the mobile-payments-enabled merchant point of sale system 225 is connected to the payment authority 120-a at the time of the purchase transaction, the point of sale system 225 may submit 255 the transaction code provided by mobile device 220 and the transaction amount to payment authority 120-a. Payment authority 120-a may route the transaction parameters to payment card system 210, which may ensure that the requested amount is available from the selected tender. If everything checks out, payment card system 210 may inform payment authority 120-a, which, in turn, conveys a return authorization to the merchant point of sale system 225, completing the transaction.

However, a network connection to the payment authority 120-a may not always be available to the merchant point of sale system 225. For example, the merchant point of sale system 225 may connect to the payment authority 120-a over a wireless or cellular network, and channel conditions, the location of the point of sale system 225, or other network issues may prevent the point of sale system 225 from accessing the network.

For at least this reason, the merchant point of sale system 225 may maintain a stored repository of offline stand-in transaction codes 285 previously received from the payment authority 120-a. The offline stand-in transaction codes may be specifically associated with the merchant point of sale system 120 at the payment authority 120-a. Thus, if the merchant point of sale system 225 is disconnected from the payment authority 120-a, the payment authority 120-a transmit one of the offline stand-in transaction codes stored locally at the merchant point of sale system 225 to the mobile device 220 for use in authorizing the transaction.

The merchant point of sale system may then compare the transaction code received from the mobile device 220 with the set of locally stored offline stand-in transaction codes 285 to determine if the transaction code from the mobile device matches one of the stored offline stand-in transaction codes 285. If a match is found, the merchant point of sale system 225 may determine that the transaction has been authorized by the payment authority 120-a, and complete the transaction with the mobile device 220. Thus, instead of relying on transmitting the transaction code received from the mobile device 220 to the payment authority 120-a, the merchant point of sale system 225 may locally authorize the transaction when there is no connectivity with the payment authority 120-a.

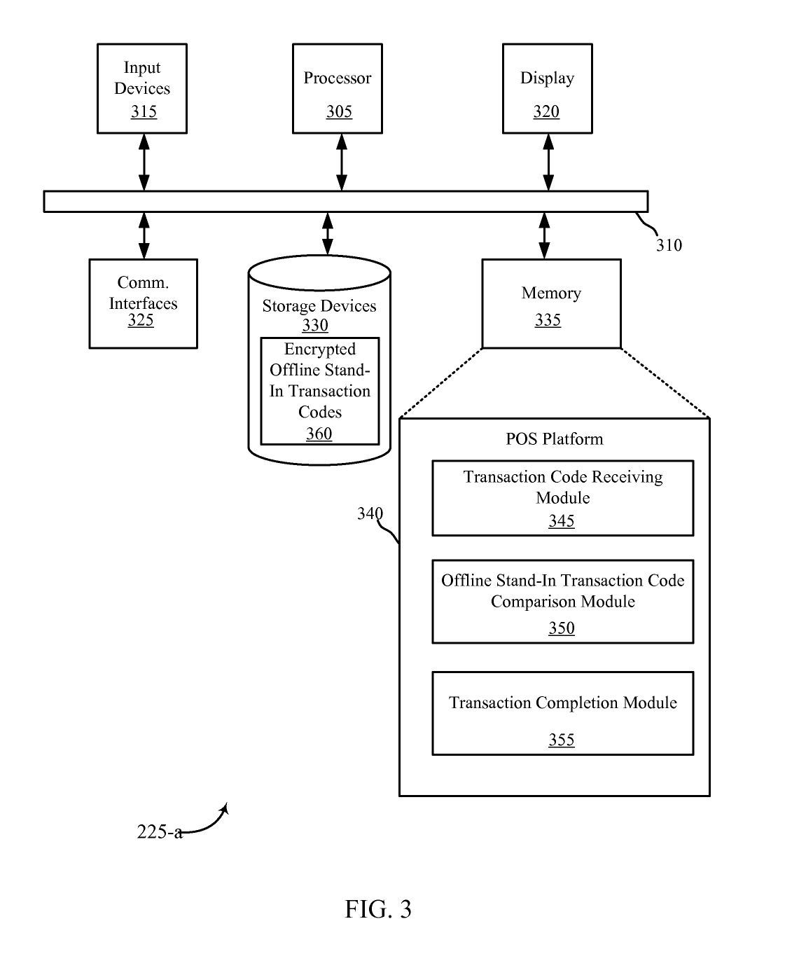

FIG. 3 is a functional block diagram of one example of a point of sale device 225-a according to the principles of the present description. The point of sale device 225-a may be an example or component of the merchant point of sale system 225 of FIG. 2. In the present example, processor 305 communicates over data bus 310 with input devices 315, display 320, communication interfaces 325, storage devices 330 (e.g., hard disk drives, floppy disk drives, optical drives, flash memory, etc.), and memory 335. Though FIG. 3 shows only a single processor, multiple processors or a multi-core processor may be present in some embodiments.

Input devices 315 may include, for example, a keyboard, a mouse or other pointing device, or other devices that are used to input data or commands to processor 305 to control the operation of the point of sale device 225-a. Communication interfaces 325 may include, for example, various serial or parallel interfaces for communicating with a network 135 (see FIG. 1) or one or more peripherals.

Memory 335 may include, without limitation, random access memory (RAM), read-only memory (ROM), flash memory, magnetic storage (e.g., a hard disk drive), processors, optical storage, or a combination of these, depending on the particular embodiment. In FIG. 3, memory 335 may contain code that, when executed by processor 305, causes processor 305 to implement a point of sale platform 340 which conducts transactions on behalf of a merchant when the point of sale platform 340 is disconnected from a network according to the principles described herein.

The point of sale platform 340 implemented by point of sale system 225-a may include at least transaction code receiving module 345, offline stand-in transaction code comparison module 350, and transaction completion module 355. Transaction code receiving module 345 may be configured to receive a mobile transaction code from a mobile device (e.g., mobile device 220 of FIG. 2) associated with a user, where the mobile transaction code is associated with an offline transaction between the mobile device and the point of sale device 225-a.

In certain examples, different transaction code lengths may be associated with offline and online transactions conducted at the point of sale system 225-a, and the point of sale system 225-a may recognize the received mobile transaction code as relating to an offline transaction based on its length. Additionally or alternatively, the point of sale system 225-a may independently determine that it is disconnected from the network and treat the received mobile transaction code as relating to an offline transaction. In additional or alternative examples, other distinguishing differences (e.g., type of characters, character patterns, etc.) may exist between transaction codes for online and offline purchases at the point of sale system 225-a. In certain examples, transaction codes used for offline purchases may have no expiration date or time, while the transaction codes used for online purchases may be perishable and associated with a set or determinable time of expiration. In some examples, the length of the offline stand-in transaction codes and/or the transaction codes used for online purchases may be variable

Upon associating the received mobile transaction code with an offline transaction, either by the length of the transaction code or by another method, the offline stand-in transaction code comparison module 350 may search for a match to the received mobile transaction code in a set of encrypted offline stand-in transaction codes 360 that were previously received from a payment authority and stored locally at the point of sale device 225-a. If a match is found, the point transaction completion module 355 may treat the transaction as having been preauthorized by the payment authority and complete the transaction with the mobile device. At this point, the transaction completion module 355 may mark the used offline stand-in transaction code as expired and render the used offline stand-in transaction code unusable indefinitely or for a predetermined period of time.

In certain examples, the transaction completion module 355 may store details related to the completed transaction for transmission to the payment authority server once network connectivity is regained. For example, the transaction completion module 355 may store and transmit at least the offline stand-in transaction code used during the transaction and an amount associated with the transaction. Once network connectivity is restored and the payment authority server receives these details, the payment authority server may authorize settlement of the transaction, transmit one or more replacement encrypted offline stand-in transaction codes to the point of sale device 225-a to replace the expended offline stand-in transaction codes.

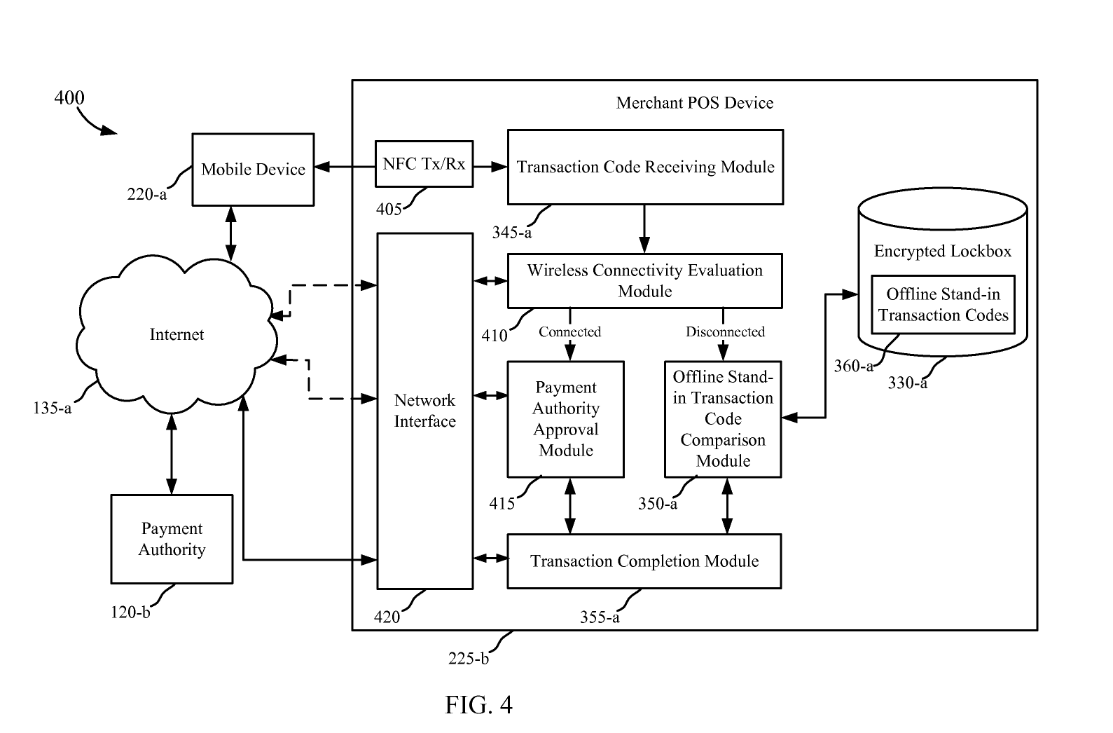

FIG. 4 is a block diagram of an example system 400 for conducting a transaction according to the principles of the present description. System 400 may be an example of one or more of the systems 100, 200 described above with respect to previous Figures. System 400 may include a payment authority server 120-b, the Internet 135-a, mobile device 220-a, and merchant point of sale (POS) device 225-b. Each of these elements of the system may be in communication with each other, directly or indirectly.

Payment authority server 120-b may be an example of the payment authority 120 described above with reference to previous Figures. The Internet 135-a may be an example of network 135 described above with reference to FIG. 1 or a network used to interconnect the components of FIG. 2. Mobile device 220-a may be an example of the mobile device 220 of FIG. 2. Merchant point of sale terminal 225-b may be an example or component of the merchant POS system(s) 225 described above with reference to previous Figures.

In the present example, the merchant point of sale device 225-b may include Near Field Communication (NFC) transceiver 405, transaction code receiving module 345-a, wireless connectivity evaluation module 410, payment authority approval module 415, offline stand-in transaction code comparison module 350-a, transaction completion module 355-a, network interface 420, and encrypted lockbox data store 330-a, which stores offline stand-in transaction codes 360-a. Each of these components may be in communication with one another, directly or indirectly.

As described in the above examples, mobile device 220-b may communicate with payment authority 120-b over the internet 135-a and/or another network to receive transaction codes to authorize transactions with merchants. When the merchant point of sale device 225-b has an active Internet connection to payment authority 120-b, the transaction code received by the mobile device 220-a from payment authority 120-b may be a dynamically generated perishable transaction code not stored at the merchant point of sale device 225-b. When the merchant point of sale device 225-b is disconnected from the payment authority 120-b, the transaction code received by mobile device 220-a from payment authority 120-b may match one of the offline stand-in transaction codes 360-a stored at the merchant point of sale device 225-b.

In the present example, the mobile device 220-b may provide the mobile transaction code received from payment authority 120-b to merchant point of sale device 225-b over an NFC link with NFC transceiver 405 or other type of connection with the merchant point of sale device 225-b. The transaction code receiving module 345-a may receive and buffer the transaction code, and the wireless connectivity evaluation module 410 may determine (e.g., by the length of the received mobile transaction code, attempting to ping payment authority 120-b, or another method) whether a connection exists to the Internet 135-a and payment authority 120-b.

If a connection exists, payment authority approval module 415 may transmit the received mobile transaction code through network interface 420 to payment authority 120-b and receive a message back from payment authority 120-b of whether the transaction is approved or rejected. If no connection exists, payment offline stand-in transaction code comparison module 350-a may search the offline stand-in transaction codes stored locally at encrypted lockbox 330-a for a match to the received mobile transaction code. If a match exists, the transaction may be approved locally at merchant point of sale device 225-b. Otherwise, the transaction may be rejected.

Upon approval or rejection of the transaction by either payment authority approval module 415 or offline stand-in transaction code comparison module 350-a, transaction completion module 355-a may complete or cancel the transaction, respectively. Once connectivity with the Internet 135-a is regained, merchant point of sale device 225-b may communicate with payment authority 120-b to settle completed transactions and receive replacement out-of-network payment codes for used or expired out-of-network payment codes 435 stored by encrypted lockbox data store 430.

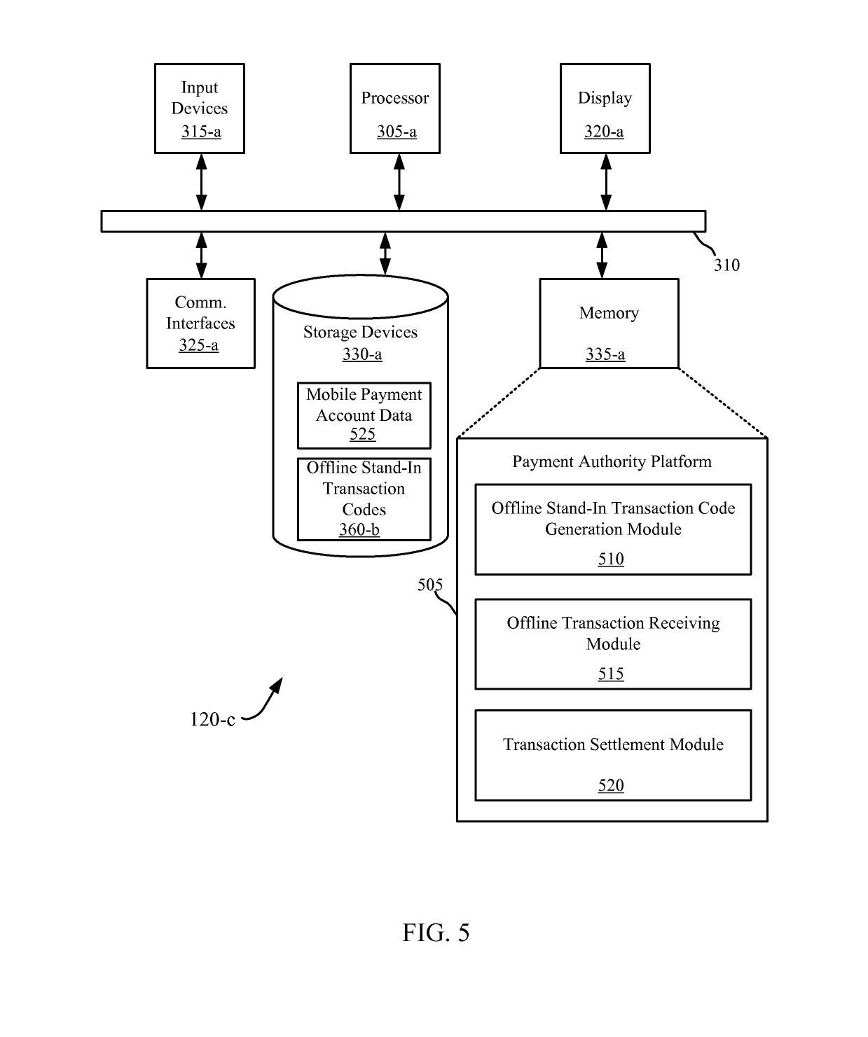

FIG. 5 is a functional block diagram of one example of a payment authority server 120-c according to the principles of the present description. The payment authority server 120-c may be an example or component of one or more of the payment authorities 120 described in the previous Figures. In the present example, processor 305-a may communicate over data bus 310-a with input devices 315-a, display 320-a, communication interfaces 325-a, storage devices 330-a (e.g., hard disk drives, floppy disk drives, optical drives, flash memory, etc.), and memory 335-a. Though FIG. 5 shows only a single processor, multiple processors or a multi-core processor may be present in some embodiments.

Input devices 315-a may include, for example, a keyboard, a mouse or other pointing device, or other devices that are used to input data or commands to processor 305-a to control the operation of the payment authority server 120-c. Communication interfaces 325-a may include, for example, various serial or parallel interfaces for communicating with a network 135 (see FIGS. 1, 4) or one or more peripherals.

Memory 335-a may include, without limitation, random access memory (RAM), read-only memory (ROM), flash memory, magnetic storage (e.g., a hard disk drive), processors, optical storage, or a combination of these, depending on the particular embodiment. In FIG. 5, memory 335-a may contain code that, when executed by processor 305-a, causes processor 305-a to implement a payment authority platform 505 which interacts with mobile devices (e.g., one or more of the mobile devices 220 of the previous Figures) and point of sale devices (e.g., one or more of the point of sale devices 225 of the previous Figures) to authorize and settle transactions using payment accounts or other accounts associated with user of the mobile devices, according to the principles described herein.

The payment authority platform 505 implemented by the payment authority server 120-c may include offline stand-in transaction code generation module 510, offline transaction receiving module 515, and transaction settlement module 520. Offline stand-in transaction code generation module 510 may generate a set of offline stand-in transaction codes specific to at least one point of sale device or merchant and transmit the set of codes to the at least one point of sale device. A copy of the offline stand-in transaction codes 360-b may also be stored at a location that is accessible to the payment authority server 120-c.

When a request to conduct a transaction at the at least one point of sale device is received at the payment authority platform 505, the payment authority platform 505 may use stored mobile payment account data 525 to determine whether the transaction is authorized based on a balance of one or more payment accounts associated with the user. If the transaction is authorized and the point of sale device is currently disconnected from the payment authority server 120-c, the offline stand-in transaction code generation module 510 may transmit one of the offline stand-in transaction codes associated with that point of sale device to the mobile device.

Upon regaining connectivity to the point of sale device, offline transaction receiving module 515 may receive from the point of sale device an indication that the offline stand-in transaction code sent to the mobile device was received by the point of sale device during an offline transaction while the payment authority server 120-c was disconnected from the point of sale device. Thus, the payment authority platform 505 may determine that the previously approved offline transaction was carried out. The offline transaction receiving module 515 may also receive other details about the approved offline transaction, such as a finalized price or transaction amount.

Transaction settlement module 520 may generate settlement instructions to tender funds or credit from the user's designated account to the merchant associated with the point of sale device using the stored mobile payment account data 525 and the transaction information received from the point of sale device. The payment authority platform 505 may additionally mark used offline stand-in transaction codes as expired for at least a predetermined period of time. The offline stand-in transaction code generation module 510 may additionally transmit replacement offline stand-in transaction codes to the point of sale device to replace the used or expired offline stand-in transaction codes associated with the point of sale device.

In certain examples, the transaction completion module 355 may store details related to the completed transaction for transmission to the payment authority server once network connectivity is regained. For example, the transaction completion module 355 may store and transmit at least the offline stand-in transaction code used during the transaction and an amount associated with the transaction. Once network connectivity is restored and the payment authority server receives these details, the payment authority server may authorize settlement of the transaction, transmit one or more replacement encrypted offline stand-in transaction codes to the point of sale device 225-a to replace the expended offline stand-in transaction codes.

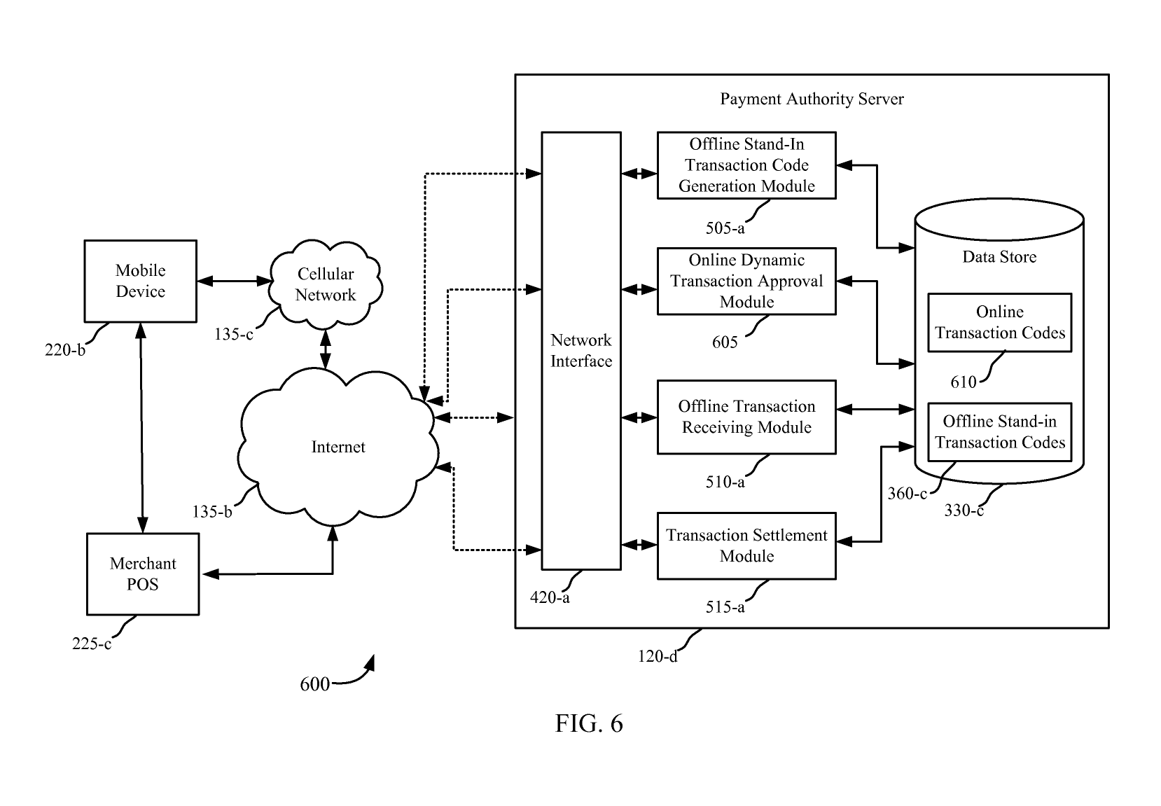

FIG. 6 is a block diagram of an example system 600 for conducting a transaction according to the principles of the present description. System 600 may be an example of one or more of the systems 100, 200, 400 described above with respect to the previous Figures. System 600 may include a payment authority server 120-d, the Internet 135-b, cellular network 135-c, mobile device 220-b, and merchant point of sale (POS) device 225-c. Each of these elements of the system may be in communication with each other, directly or indirectly.

Payment authority server 120-d may be an example of one or more of the payment authorities 120 described above with reference to previous Figures. The Internet 135-b and cellular network 135-c may be an example of one or more of the networks 135 described above with reference to previous Figures. Mobile device 220-b may be an example of one or more of the mobile devices 220 of previous Figures. Merchant point of sale terminal 225-c may be an example or component of one or more of the merchant POS system(s) 225 described above with reference to previous Figures.

In the present example, the payment authority server 120-d may include network interface 420-a, offline stand-in code generation module 505-a, online dynamic transaction approval module 605, offline stand-in transaction receiving module 510-a, transaction settling module 515-a, and data store 330-b, which stores online transaction codes 610 and offline stand-in transaction codes 360-b generated for various point of sale devices or groups of point of sale devices associated with a common merchant.

As described in the above examples, mobile device 220-b may communicate with payment authority server 120-d over cellular network 135-c and the Internet 135-b request a transaction codes for a transaction with a merchant associated with merchant point of sale device 225-c. When the merchant point of sale device 225-c has an active Internet connection to payment authority server 120-d, the transaction code received by the mobile device 220-b from payment authority server 120-d may be a dynamically generated perishable transaction code not stored at the merchant point of sale device 225-c. When the merchant point of sale device 225-c is disconnected from the payment authority server 120-d, the transaction code received by mobile device 220-b from payment authority server 120-d may match an offline stand-in transaction codes 360-c stored at the merchant point of sale device 225-b that was previously generated at offline stand-in transaction code generation module 505-a and transmitted to merchant point of sale device 225-c over the Internet 135-b.

If a connection to payment authority server 120-d exists, merchant point of sale device 225-c may transmit the received mobile transaction code through network interface to payment authority server 120-d, and online dynamic transaction approval module 605 may compare the transaction code received from merchant point of sale system to the transaction code transmitted to mobile device 220-b to dynamically approve or reject the transaction. If the codes match, online dynamic transaction approval module 605 may transmit an approval code back to the point of sale device 225-c.

If no connection exists to payment authority server 120-d exists, point of sale device 225-c may locally approve the transaction based on a comparison of the transaction code received from the mobile device 220-b with one of the offline stand-in transaction codes stored locally at the merchant point of sale device 225-c. The offline transaction receiving module 510-a may receive an indication of offline transactions locally approved by the merchant point of sale device 225-c and the transaction settlement module 515-a may issue settlement instructions for approved transactions.

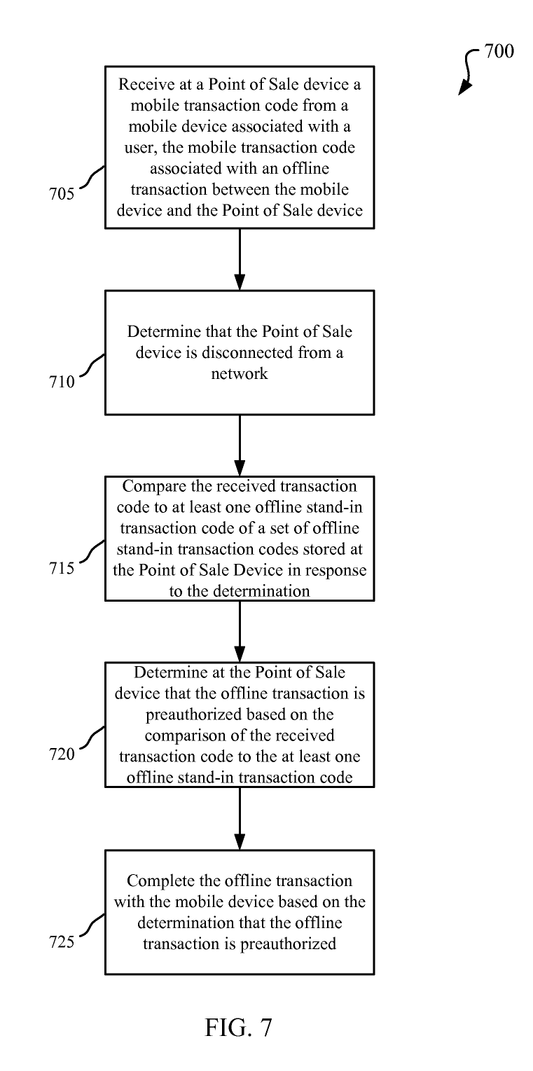

FIG. 7 depicts an example method 700 of conducting transactions at a point of sale device, according to the principles of the present description. The method 700 may be performed by one or more of the point of sale devices 225 described above with reference to previous Figures.

At block 705, a mobile transaction code may be received at the point of sale device from a mobile device associated with a user. The mobile transaction code may be associated with an offline transaction between the mobile device and the point of sale device during which the point of sale device is disconnected from a network. At block 710, the point of sale device may determine that it is disconnected from the network, and therefore, from a payment authority.

At block 715, the point of sale device may compare the received mobile transaction code to at least one offline stand-in transaction code stored at the point of sale device in response to the determination that the point of sale device is disconnected from the network.

At block 720, the point of sale device may determine that the offline transaction is preauthorized based on the comparison of the received mobile transaction code tot eh at least one offline stand-in transaction code. At block 725, the offline transaction may be completed with the mobile device based on the determination at the point of sale device that the offline transaction is preauthorized.

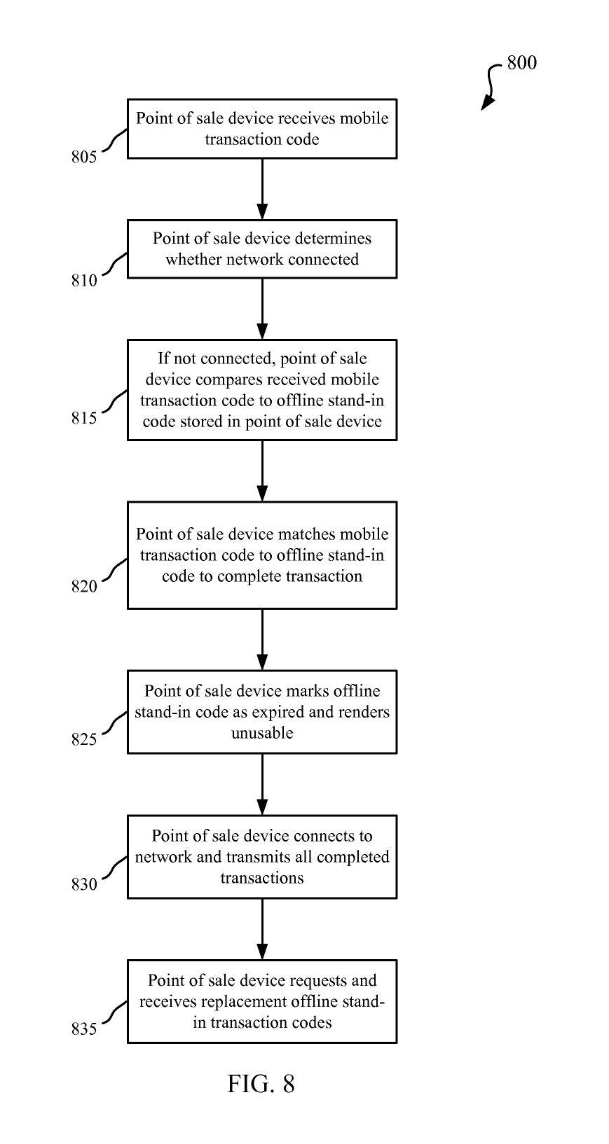

FIG. 8 depicts an example method 800 of conducting a transaction at a point of sale device, according to the principles of the present description. The method 800 may be performed by one or more of the point of sale devices 225 described above with reference to previous Figures. The method 800 may be an example of the method 700 of FIG. 7.

At block 805, the point of sale device may receive a mobile transaction code. At block 810, the point of sale device may determine whether a network connection is available. If no connection is available, the point of sale device may decrypt the encrypted area of the point of sale device and compare the received mobile transaction code to at least one locally stored offline stand-in transaction code at block 815. At block 820, the point of sale device may determine that the received mobile transaction code matches the at least one offline stand-in transaction code, thereby authorizing the point of sale device to complete the transaction and store the transaction details at the point of sale device.

At block 825, the point of sale device may mark the matched offline stand-in transaction code as expired and renders the expired code unusable. At block 830, the point of sale device may reconnect to the network and transmit the transaction details of the completed transactions that took place while the system was offline. At block 835, the point of sale device may then request, receive, and store a set of replacement offline stand-in codes in the encrypted area of the point of sale device. The encrypted area of the point of sale device may store a number of one-time use codes. In certain examples, the offline stand-in codes may be replaced en masse or individually on a regular schedule.

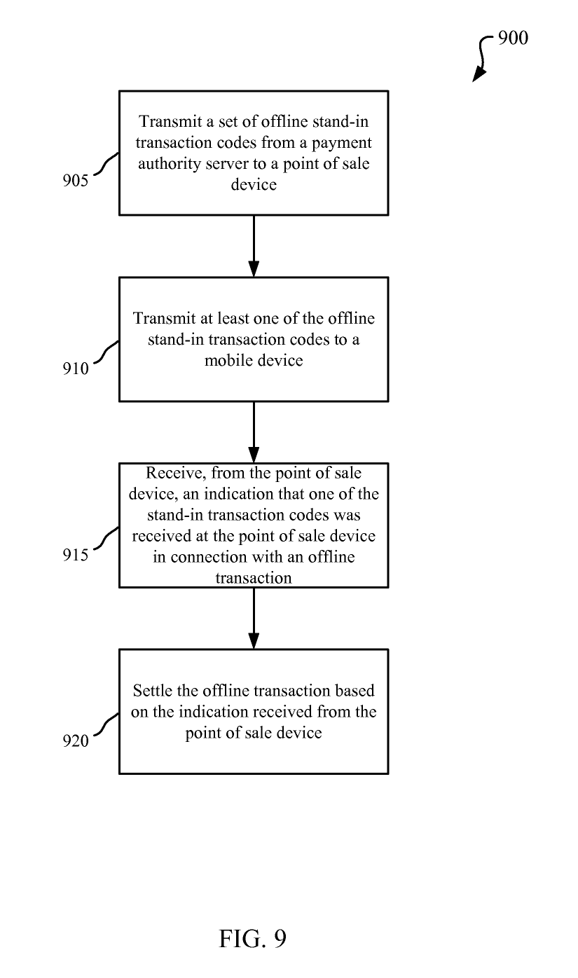

FIG. 9 depicts an example method 900 of conducting transactions at a payment authority server, according to the principles of the present description. The method 900 may be performed by one or more of the payment authorities 120 described above with reference to previous Figures.

At block 905, a set of offline stand-in transaction codes may be transmitted from the payment server to a point of sale device. At block 910, at least one of the offline stand-in transaction codes may be transmitted to a mobile device in connection with a transaction request. At block 915, an indication may be received at the payment authority server from the point of sale device that one of the offline stand-in transaction codes was received at the point of sale device in connection with an offline transaction. At block 920, the offline transaction may be settled at the payment authority server based on the indication received from the point of sale device.

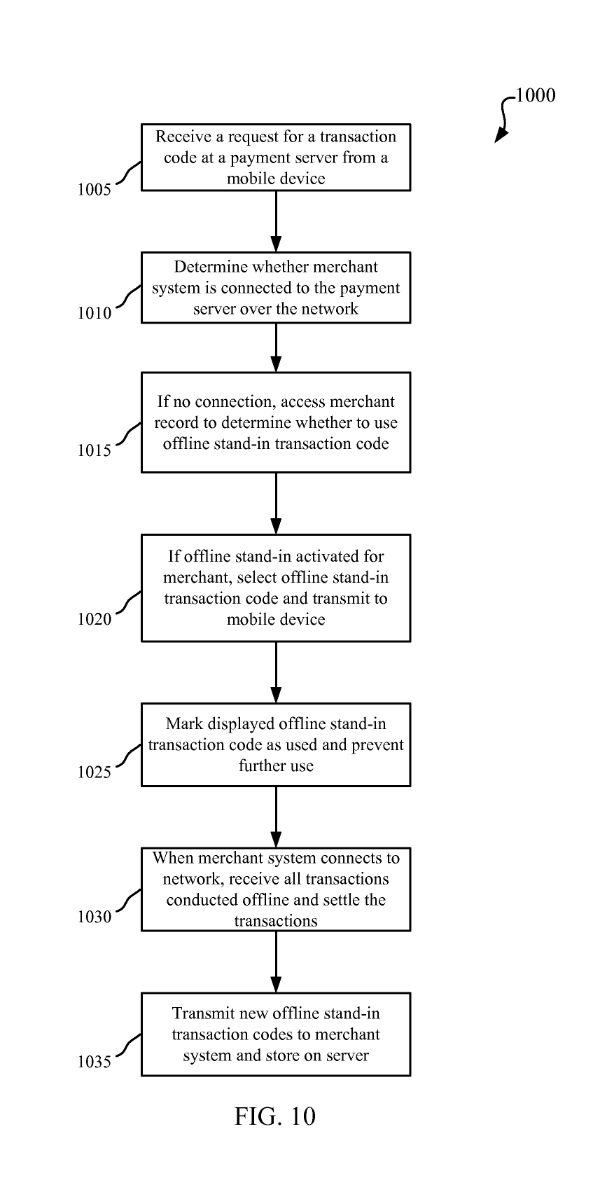

FIG. 10 depicts another example method 1000 of conducting transactions at a payment authority server, according to the principles of the present description. The method 1000 may be performed by one or more of the payment authorities 120 described above with reference to previous Figures. The method 1000 may be an example of the method 900 of FIG. 9.

At block 1005, the payment authority server may receive a request for a transaction code from a mobile device. At block 1010, the payment authority server may determine whether a merchant associated with a point of sale system is connected to the payment authority server over a network. At block 1015, if no connection exists, the payment authority server may access a record associated with the merchant to determine whether the merchant has activated the ability to use offline stand-in transaction codes. At block 1020, if the merchant has activated offline stand-in transaction codes, the payment authority server may select one of the offline stand-in transaction codes stored locally at the point of sale system and transmit the selected code to the mobile device.

The mobile device user may then show or provide the received transaction code to the merchant. At block 1020, the payment authority server, meanwhile, may mark the selected offline stand-in transaction code as used and expired, and prevent any further use of that transaction code for at least a predetermined period. At block 1030, when the merchant's point of sale system reconnects to the network, the payment authority server may receive the transaction details of the completed transaction from the merchant's point of sale system 635 and settle those transactions. At block 1035, the payment authority server may then generate a new set of offline stand-in transaction codes, transmit them to the merchant's POS system, and store the new set of offline stand-in transaction codes on the payment authority server. The offline stand-in codes may also be replaced en masse or individually on a time basis on any schedule, for example, daily, weekly, or monthly.

The components described in the Figures of the present disclosure may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of each unit may also be implemented, in whole or in part, with instructions embodied in a memory, formatted to be executed by one or more general or application-specific processors.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a SIM card, other smart cards, and various other mediums capable of storing, containing or carrying instructions or data.

Furthermore, embodiments may be implemented by hardware, software, firmware, middleware, microcode, hardware description languages, or any combination thereof When implemented in software, firmware, middleware or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method of conducting transactions, comprising:
receiving, at a point of sale device, a mobile transaction code from a mobile device associated with a user, the mobile transaction code associated with an offline transaction between the mobile device and the point of sale device during which the point of sale device is disconnected from a network;
comparing the received mobile transaction code at the point of sale device to at least one stored offline stand-in transaction code in response to a determination that the point of sale device is disconnected from the network;
determining at the point of sale device that the offline transaction is preauthorized based on the comparison of the received mobile transaction code to the at least one offline stand-in transaction code; and
completing the off-line transaction based on the determination that the offline transaction is preauthorized.

2. The method of claim 1, further comprising:
recognizing the received mobile transaction code as relating to an offline transaction based on a length of the received mobile transaction code.

3. The method of claim 2, further comprising:
searching the stored offline stand-in transaction codes for a match to the received mobile transaction code in response to determining the length of the received mobile transaction code.

4. The method of claim 2, wherein a length of the offline stand-in transaction codes is different from a length associated with perishable transaction codes used to authorize transactions occurring while the point of sale device is connected to the network.

5. The method of claim 1, further comprising:
marking the offline stand-in transaction code as expired; and
rendering the offline stand-in transaction code unusable.

6. The method of claim 1, further comprising:
transmitting at least one completed transaction from the point of sale device to the network in response to the point of sale device reconnecting to the network.

7. The method of claim 1, further comprising:
receiving at least one replacement offline stand-in transaction code from the network at the point of sale device in response to the point of sale device reconnecting to the network; and
storing the at least one replacement offline stand-in transaction code in the set of stored offline stand-in transaction codes of the point of sale device.

8. The method of claim 1, wherein a length of the mobile transaction code and the offline stand-in transaction code is variable.

9. The computer-server based method of claim 1, wherein the offline stand-in transaction codes have no expiration date.

10. The method of claim 1, further comprising:
encrypting the offline stand-in transaction codes stored on the point of sale device.

11. A method for conducting transactions at a payment authority server, comprising:
transmitting a set of offline stand-in transaction codes generated at the payment authority server to a point of sale device;
transmitting at least one of the offline stand-in transaction codes to a mobile device;
receiving, from the point of sale device, an indication that one of the offline stand-in transaction codes was received at the point of sale device from the mobile device in connection with an offline transaction during which the point of sale device and the payment authority server were disconnected; and
settling the offline transaction based on the indication received from the point of sale device.

12. The method of claim 11, further comprising:
marking the one of the stand-in transaction codes received at the point of sale device in connection with the offline transaction as expired and unusable for at least a predetermined period of time.

13. The method of claim 11, further comprising:
transmitting a replacement offline stand-in transaction code to the merchant computer system in response to the indication that the one of the stand-in transaction codes was received at the point of sale device from the mobile device in connection with the offline transaction.

14. The method of claim 11, wherein a length of the offline stand-in transaction codes is variable.

15. The method of claim 11, wherein a length of the offline stand-in transaction codes is different from a length of perishable transaction codes used to authorize transactions during which the point of sale device is connected to the network.

16. The method of claim 11, wherein the offline stand-in transaction codes have no expiration date.

17. A point of sale device, comprising:
a processor;
a memory communicatively coupled with the processor, the memory storing instructions executable by the processor to:
receive, at a point of sale device, a mobile transaction code from a mobile device associated with a user, the mobile transaction code associated with an offline transaction between the mobile device and the point of sale device during which the point of sale device is disconnected from a network;
compare the received mobile transaction code at the point of sale device to at least one stored offline stand-in transaction code in response to a determination that the point of sale device is disconnected from the network;
determine at the point of sale device that the offline transaction is preauthorized based on the comparison of the received mobile transaction code to the at least one offline stand-in transaction code; and
complete the off-line transaction based on the determination that the offline transaction is preauthorized.

18. The point of sale device of claim 17, the memory further storing instructions executable by the processor to:
recognize the received mobile transaction code as relating to an offline transaction based on a length of the received mobile transaction code.

19. The point of sale device of claim 18, the memory further storing instructions executable by the processor to:
search the stored offline stand-in transaction codes for a match to the received mobile transaction code in response to determining the length of the received mobile transaction code.

20. The point of sale device of claim 18, wherein a length of the offline stand-in transaction codes is different from a length associated with perishable transaction codes used to authorize transactions occurring while the point of sale device is connected to the network.

21. A payment authority server, comprising:
a processor;
a memory communicatively coupled with the processor, the memory storing instructions executable by the processor to:
transmit a set of offline stand-in transaction codes generated at the payment authority server to a point of sale device;
transmit at least one of the offline stand-in transaction codes to a mobile device;
receive, from the point of sale device, an indication that one of the offline stand-in transaction codes was received at the point of sale device from the mobile device in connection with an offline transaction during which the point of sale device and the payment authority server were disconnected; and
settle the offline transaction based on the indication received from the point of sale device.

22. The method of claim 11, further comprising:
marking the one of the stand-in transaction codes received at the point of sale device in connection with the offline transaction as expired and unusable for at least a predetermined period of time.
